(19) United States
(12) Patent Application Publication
(10) Pub. No.: US 2007/0210547 A1
(43) Pub. Date: Sep. 13, 2007

(54) Apparatus for holding a paint tray

(76) Inventor: Mark R. Ellis, Superior, WI (US)

Correspondence Address: JAMES RAY & ASSOCIATES, 2640 Pitcairn Road, Monroeville, PA, 15146, US

(21) Appl. No.: 11/651,630

(22) Filed: Jan. 9, 2007

Related U.S. Application Data
(60) Provisional application No. 60/757,304, filed on Jan. 9, 2006.

(51) Int. Cl. A47K 1/04; B62B 1/00

(52) U.S. Cl. 280/79.2

(57) ABSTRACT

An apparatus for holding a paint tray which allows such tray to be readily moved without risk of spilling paint therefrom. Such apparatus includes a frame member having at least three vertically disposed side wall members. A predetermined length of two of these side wall members being longer that is a predetermined length of any remaining side wall members. Further, there is at least one horizontally disposed support member positioned at least one of intermediate each end of such side wall members and below a bottom surface of such side wall members. The final essential element of the frame member is a plurality of leg members disposed closely adjacent an outer perimeter of and attached to such frame member. Rollers are attached to a bottom of each of such leg members for facilitating movement of such apparatus over a surface and a handle is attached to such frame member for moving the apparatus as required while painting.

### CROSS-REFERENCE TO RELATED APPLICATION

This application relates to and claims priority from U.S. Provisional Patent Application Ser. No. 60/657,304 filed Jan. 9, 2006.

### FIELD OF INVENTION

The present invention relates, in general, to painting accessories and, more particularly, this invention relates to an apparatus for a holding a paint tray in a more advantageous position for painting.

### BACKGROUND OF THE INVENTION

Prior to the present invention, a paint tray is either hooked unto a ladder when it is in use or set on a table or floor. When the user is finished with the tray and it is left on the ladder it is unstable and may spill paint therefrom. if the tray is left on the floor it has to be continuously moved, or get kicked around by the user.

The chances for accidentally spilling paint is, therefore, greatly increased. Additionally, clean up of such spilt paint is time consuming and if the paint is spilled on carpet it may be impossible to get out.

Further, the paint is no longer useable thereby adding to the expense on painting.

### SUMMARY OF THE INVENTION

In a first aspect, the present invention provides an apparatus for holding a paint tray in a more convenient position during painting and which allows such tray to be readily moved without the risk of spilling the paint contained therein. Such apparatus includes a generally rectangular frame member formed from a predetermined material. This frame member includes at least three elongated and vertically disposed side wall members. Such side wall members each have a first predetermined length, a first predetermined width and a first predetermined depth. The first predetermined length of two of these at least three side wall members being longer that is the first predetermined length of any remaining side wall members. Further, there is at least one elongated horizontally disposed support member having each of a second predetermined length a second predetermined width and a second predetermined depth being positioned at least one of intermediate each end of such side wall members and below a bottom surface of such side wall members. The final essential element of the frame member is a plurality of leg members disposed closely adjacent an outer perimeter of and attached to such frame member. Roller means are attached to a bottom of each of such leg members for facilitating movement of such apparatus over a surface and a handle means is attached to such frame member for moving the apparatus as required while painting.

### OBJECTS OF THE INVENTION

It is therefore one of the primary objects of the invention to provide an apparatus for holding a paint tray during painting which is relatively easy to use.

Another object of the present invention is to provide a paint tray which will substantially minimize the spillage of paint.

Still another object of the present invention is to provide a paint tray which is relatively inexpensive to manufacture.

Yet another object of the present invention is to provide a paint tray which can be stored in a relatively small space when not in use.

An additional object of the present invention is to provide a paint tray which is easily transported between job sites.

A further object of the present invention is to provide an apparatus for holding a paint tray which can be manufactured from a variety of materials.

In addition to the various objects of the invention that have been described above, various other objects and advantages of the invention will become more readily apparent to those persons skilled in the relevant art from the following more detailed description of the invention, particularly, when such description is taken in conjunction with the attached drawing figures and appended claim.

### BRIEF DESCRIPTION OF THE DRAWINGS

FIG. 1 is a perspective view of the apparatus for holding a paint tray according to a presently preferred embodiment of the invention;

FIG. 2 is a perspective view of the apparatus for holding a paint tray according to an alternative embodiment of the present invention; and

FIG. 3 is a bottom view of the apparatus for holding a paint tray illustrated in FIG. 2.

### BRIEF DESCRIPTION OF A PRESENTLY PREFERRED AND VARIOUS ALTERNATIVE EMBODIMENTS OF THE PRESENT INVENTION

Prior to proceeding to the more detailed description of the present invention it should be noted that, for the sake of clarity and understanding, identical components having identical functions have been identified with identical reference numerals throughout the several views illustrated in the attached drawing figures.

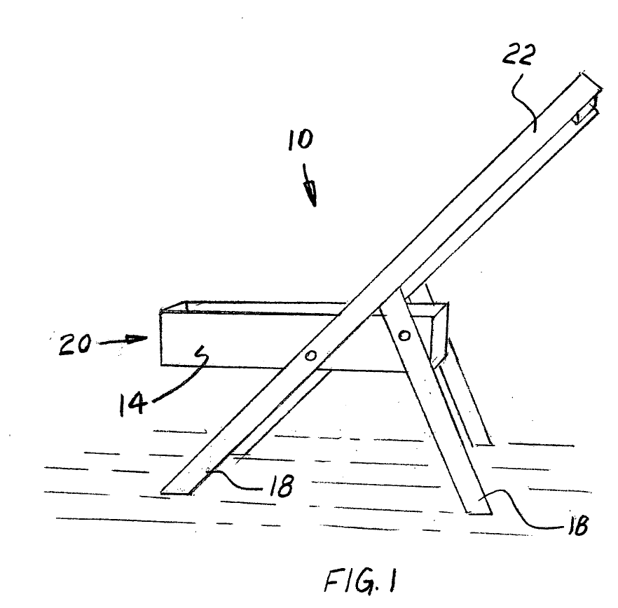

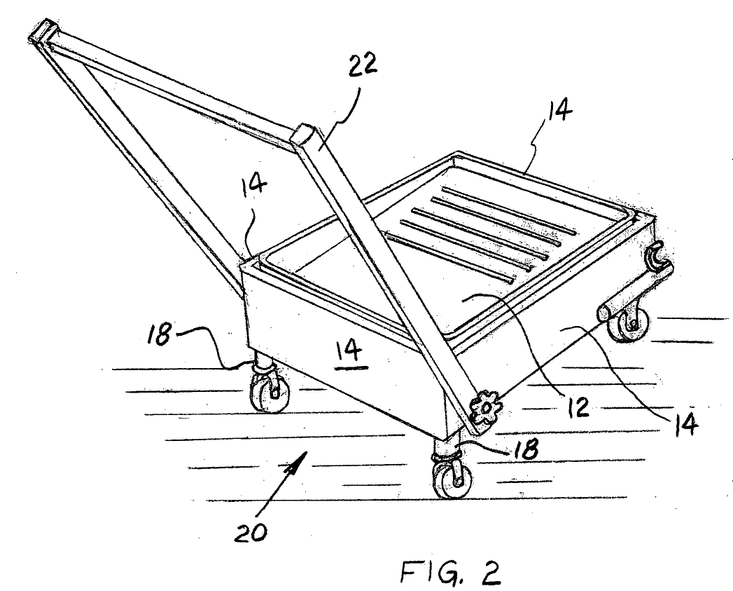

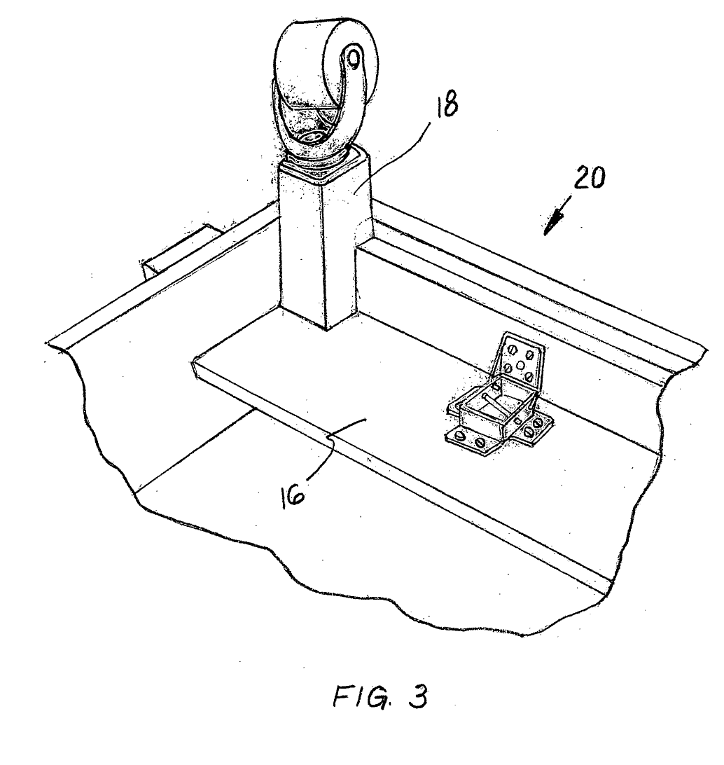

Now reference is made more particularly to FIGS. 1-3 of the drawings. Illustrated therein is an apparatus, generally designated 10, for holding a paint tray 12 in a more convenient position during painting and which allows such tray 12 to be readily moved. The apparatus 10 comprises a generally rectangular frame member, generally designated 20, formed from a predetermined material. Such predetermined material is selected from the group consisting of wood and plastic with the presently preferred material being wood.

The frame member 20 includes at least three elongated and preferably four vertically disposed side wall members 14. These side wall members 14 each have a first predetermined length, a first predetermined width and a first predetermined depth. The first predetermined length of two of such at least three side wall members 14 being longer that the first predetermined length of any remaining side wall members 14.

There is at least one and preferably two elongated horizontally disposed support members 16 having each of a second predetermined length, a second predetermined width and a second predetermined depth positioned at least one of intermediate each end of such side wall members 14 and below a bottom surface of such side wall members 14.

A plurality of leg members 18 which are disposed closely adjacent an outer perimeter of and attached to such frame member 20. Preferably, such frame member 20 will include four leg members 18, and which are pivotable, positioned adjacent each corner of such frame member 20.

Additionally, apparatus 10 includes a roller means attached to a bottom of each of the leg members 18 for facilitating movement of such apparatus 10 over a surface. Preferably, the roller means are casters.

There is also a handle means 22 attached to such frame member 20 for moving the apparatus 10 as required while painting.

While in accordance with the patent statutes both a presently preferred and an alternative embodiment of the present invention have been described in sufficient detail above to enable anyone skilled in the relevant art to make and use the same it should be noted that various other adaptations and modifications can be envisioned without departing from the spirit of the invention and the scope of the appended claims.

I claim:

1. An apparatus for holding a paint tray in a more convenient position during painting and which allows such tray to be readily moved, said apparatus comprising:
(a) a generally rectangular frame member formed from a predetermined material, said frame member including;
(i) at least three elongated vertically disposed side wall members having each of a first predetermined length, a first predetermined width and a first predetermined depth, said first predetermined length of two of said at least three side wall members being longer that said first predetermined length of any remaining side wall members, and
(ii) at least one elongated horizontally disposed support member having each of a second predetermined length a second predetermined width and a second predetermined depth positioned at least one of intermediate each end of such side wall members and below a bottom surface of such side wall members;
(b) a plurality of leg members disposed closely adjacent an outer perimeter of and attached to said frame member;
(c) roller means attached to a bottom of each of said leg members for facilitating movement of said apparatus over a surface; and
(d) a handle means attached to said frame member for moving said apparatus as required while painting.

2. An apparatus, according to claim 1, wherein said predetermined material said frame member is formed from is selected from the group consisting of wood and plastic.

3. An apparatus, according to claim 2, wherein said predetermined material said frame member is formed from is wood.

4. An apparatus, according to claim 1, wherein said frame member includes four elongated vertically disposed side wall members.

5. An apparatus, according to claim 1, wherein said frame member includes two elongated horizontally disposed support members.

6. An apparatus, according to claim 1, wherein said frame members includes four leg members, one of said four leg members being positioned adjacent each corner of said frame member.

7. An apparatus, according to claim 6, wherein said roller means are casters.

8. An apparatus, according to claim 6, wherein said four leg members are pivotable.
